(19) United States
(12) Patent Application Publication
(10) Pub. No.: US 2026/0243164 A1
(43) Pub. Date: Aug. 20, 2026

(54) DOWNHOLE EVENT DETECTION AND MODIFIED MUD LOGGING

(71) Applicant: Schlumberger Technology Corporation, Sugar Land, TX (US)

(72) Inventors: Elias Temer, Clamart (FR); Hakim Arabi, Houston, TX (US); David Casado, Versailles (FR); Prashant Sharma, Boulogne Billancourt (FR)

(21) Appl. No.: 19/206,560

(22) Filed: May 13, 2025

(30) Foreign Application Priority Data
Feb. 19, 2025 (EP) 25305225.2

(51) Int. Cl. E21B 49/00; E21B 47/12; G01V 11/00

(52) U.S. Cl. CPC E21B 49/005; G01V 11/002; E21B 47/12; E21B 2200/20

(57) ABSTRACT

A method for classifying a downhole event includes acquiring logging while drilling (LWD) measurements in a downhole processing system that includes a trained deep learning model. The received LWD measurements are evaluated using the trained model to classify a drilling event. The classification classifies a change in a composition of the annular drilling fluid and enables a zone of interest in the subterranean formation to be identified.

### CROSS REFERENCE TO RELATED APPLICATIONS

None.

### BACKGROUND

Drilling operations commonly make extensive use of logging while drilling (LWD) and mud logging operations to characterize the subterranean formations traversed by the drilled wellbore. For example, commonly employed LWD measurements include resistivity measurements, sonic and ultrasonic measurements, nuclear magnetic resonance measurements, natural and induced gamma ray measurements, and the like. During such operations, a selected and compressed portion of the LWD measurements may be transmitted to the surface in real time while drilling. The measurements are generally further saved to downhole memory and evaluated in more detail after the completion of the drilling operation (or the removal of the LWD tool from the wellbore).

Mud logging operations commonly evaluate hydrocarbon (and other) gases in the drilling fluid as well as the cuttings particles generated during drilling. It will be appreciated that cuttings particles are abundant in volume and number and may provide one of the lowest cost and most abundant data sources for understanding and characterizing the subsurface rock and formation properties. However, the cuttings particles are so abundant that it is impossible to evaluate more than a very small fraction of the particles generated. As a result, cuttings particles are commonly sampled at predetermined time or depth intervals during the drilling operation. While these procedures provide useful information, they can miss various formation layers (e.g., thin layers) or other zones of interest. There is a need in the industry for improved logging methods that enable a more complete mud logging evaluation, particularly of gas generating zones of interest.

### BRIEF DESCRIPTION OF THE DRAWINGS

For a more complete understanding of the disclosed subject matter, and advantages thereof, reference is now made to the following descriptions taken in conjunction with the accompanying drawings, in which:

FIG. 1 depicts an example drilling rig including an example system for evaluating cuttings particles.

FIG. 2 depicts a schematic of an example wellbore.

FIG. 3 depicts a flow chart of one example method for classifying a drilling event.

FIGS. 4A and 4B (collectively FIG. 4) depict ultrasonic LWD (4A) and electromagnetic LWD (4B) measurements being impacted by cuttings particles and/or gas bubbles in the drilling fluid.

FIG. 5 depicts a schematic of an example drilling operation implementing the disclosed system and method for detecting a zone of interest.

FIG. 6 depicts a block diagram of an example event classification.

FIG. 7 depicts an example deep learning model configured for use in the disclosed embodiments.

FIG. 8 depicts a flow chart of another example method for classifying a drilling event.

### DETAILED DESCRIPTION

Embodiments of this disclosure include systems and methods for classifying a downhole event while drilling. In one example embodiment, a disclosed method includes making logging while drilling (LWD) measurements in a wellbore penetrating a subterranean formation. The LWD measurements are received in a downhole processing system that includes a trained deep learning model. The LWD measurements are evaluated using the trained model to classify a drilling event. The classification classifies a change in a composition of the annular drilling fluid and enables a zone of interest in the subterranean formation to be identified. Additional mud logging samples may optionally be acquired in the identified zone of interest.

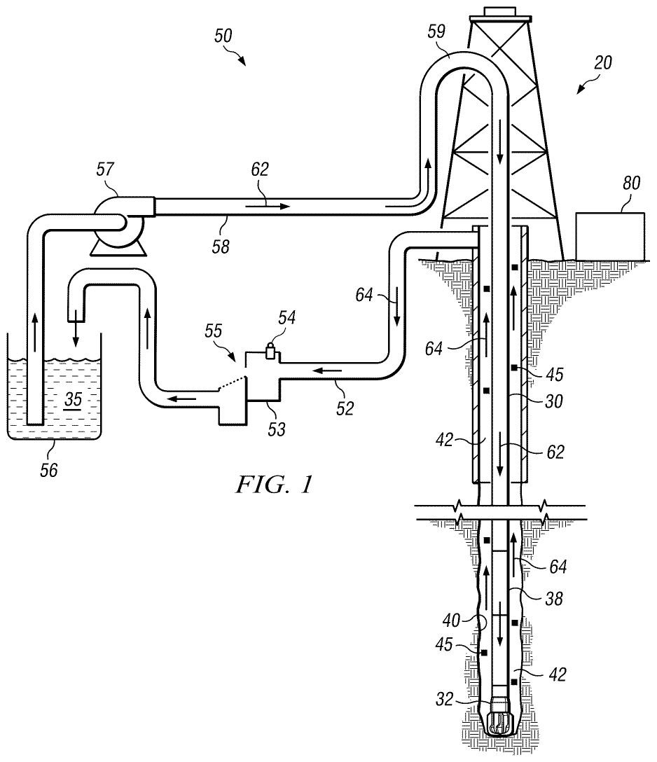

FIG. 1 depicts an example drilling rig 20 including a surface laboratory 80 for evaluating formation gases and/or cuttings particles that are acquired from circulating drilling fluid on the rig. The drilling rig 20 may be positioned over a subterranean formation (not shown) and may include, for example, a derrick and a hoisting apparatus (also not shown) for raising and lowering a drill string 30 into and out of a wellbore 40. The string 30 may include, for example, a drill bit 32, and one or more downhole logging while drilling tools 38 (e.g., an ultrasonic LWD tool or a resistivity LWD tool) deployed in a bottom hole assembly (BHA) above the bit 32. As described in more detail below, the BHA may further include an electronic processing engine configured to characterize or classify the LWD measurements to identify a drilling event. It will be appreciated that the BHA may optionally further include other tools or systems, for example, including an MWD tool, a telemetry tool, and a steering tool, such as a rotary steerable tool. It will be further appreciated that the disclosed embodiments are not limited to any particular BHA configuration.

In the depicted example, drilling rig 20 further includes a surface system 50 for controlling the flow of drilling fluid used on the rig (e.g., used in drilling the wellbore 40). In the example rig depicted, drilling fluid 35 is pumped downhole (as depicted at 62), for example, via a conventional mud pump 57. The drilling fluid 35 may be pumped, for example, through a standpipe 58 and mud hose 59 in route to the drill string 30. The drilling fluid 35 typically emerges from the drill string 30 at or near the drill bit 32 and creates an upward flow 64 of mud through the wellbore annulus 42 (the annular space between the drill string and the wellbore wall). The drilling fluid 35 then flows through a return conduit 52 to a mud pit system 56 where it may be recirculated. It will be appreciated that the terms drilling fluid and mud are used synonymously herein.

The circulating drilling fluid 35 is intended to perform many functions during a drilling operation, one of which is to carrying drill cuttings 45 to the surface (in upward flow 64). The drill cuttings 45 are commonly removed from the returning mud via a shale shaker 55 (or other similar solids control equipment) in the return conduit (e.g., immediately upstream of the mud pits 56). Formation gases (not shown) that are released during drilling may also be carried to the surface (e.g., as bubbles) in the circulating drilling fluid 35. These gasses are commonly removed from the fluid, for example, via a degasser or gas trap 54 located in or near a header tank 53 that is immediately upstream of the shale shaker 55 in the example depiction. The drill cuttings 45 may be evaluated to characterize the subterranean formation and/or estimate various properties thereof as described in more detail below.

While FIG. 1 depicts a land rig 20, it will be appreciated that the disclosed embodiments are equally well suited for land rigs or offshore rigs. As is known to those of ordinary skill, offshore rigs commonly include a platform deployed atop a riser that extends from the sea floor to the surface. The drill string extends downward from the platform, through the riser, and into the wellbore through a blowout preventer (BOP) located on the sea floor. The disclosed embodiments are not limited in these regards.

As mentioned above in the Background Section, cuttings particles are commonly sampled at predetermined time or measured depth intervals during a drilling operation (e.g., at intervals of about 30 meters). The collection procedures may also include taking additional samples at various depths or times to reduce the likelihood of missing zones of particular interest. The additional samples may be taken, for example, randomly or based on knowledge obtained from geological surveys and/or previously drilled wells. Notwithstanding, it will be appreciated that these sampling procedures may be thought of as being “blind” in that they sample the drill cuttings in a random or partially random way without guidance or knowledge regarding the properties or fluid bearing potential of the sampled region.

One aspect of the disclosed embodiments was the realization that LWD measurements may be thought of as “seeing” the subterranean formation or wellbore conditions while drilling in that they provide valuable information regarding the wellbore conditions and formation properties and that these LWD measurements may be evaluated (e.g., summarized or classified) and transmitted to the surface via a telemetry tool before the drill cuttings arrive at the surface. It was therefore realized that LWD measurements may be used to guide the acquisition of cuttings samples.

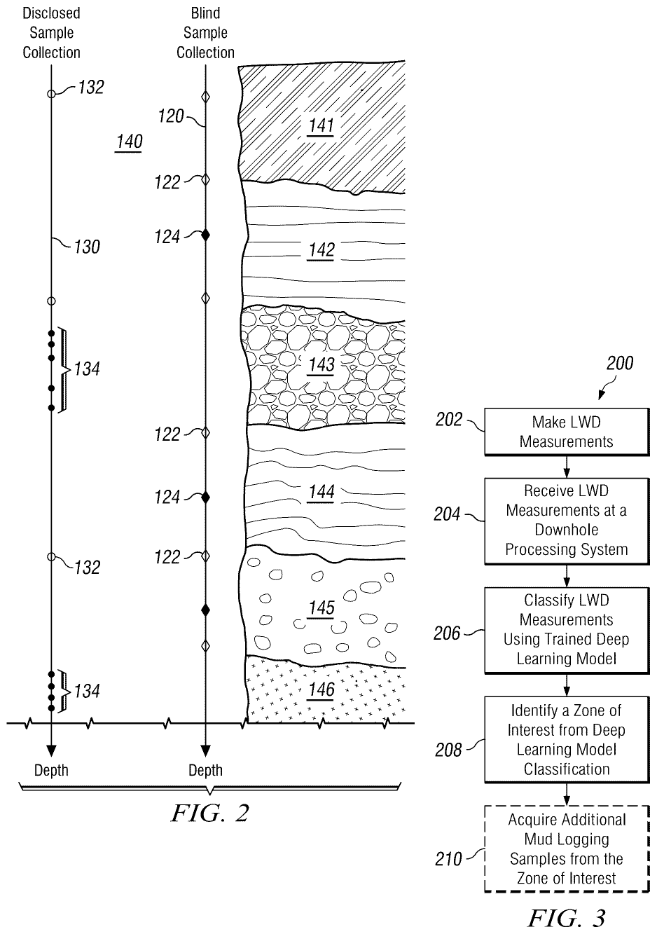

FIG. 2 depicts a schematic of an example wellbore 140. As depicted the example wellbore traverses several formation layers 141, 142, 143, 144, 145, 146 of which two layers 143 and 146 represent first and second zones of interest (or zones of potential interest). Also schematically depicted on the righthand side of the wellbore 140 is a prior art “blind” sample collection procedure plan 120. The depicted example plan 120 may include scheduled samplings 122 spaced at a depth interval (e.g., an interval of 30 meters) along the length of the wellbore 140. The example plan 120 may further include spontaneous samplings 124. As described above, these spontaneous samplings 124 may be purely random or may be selected based upon a priori knowledge of the local geology. In the depicted example plan 120, the first and second zones 143, 146 of interest are missed (meaning that no samples are taken from those zones 143, 146). It will be appreciated that failing to sample the zones of interest may potentially lead to a significant loss of information regarding the subterranean environment which may in turn result in lost production potential of the well. It will further be appreciated that the likelihood of missing any particular zone of interest tends to increase with decreasing thickness of the zone or layer (i.e., thin zones are more likely to be missed) and increased spacing between the scheduled samplings.

FIG. 2 further depicts an alternative sampling plan 130 using the disclosed systems and methods. Sampling plan 130 may advantageously be adjusted or updated in real-time while drilling the wellbore 140 based on a deep learning model assessment of LWD measurements. Sampling plan 130 is similar to plan 120 in that it may include the scheduled samplings 132 that are spaced at a prescribed depth interval along the wellbore 140. Sampling plan 130 differs from plan 120 in that it includes additional samplings 134 closely spaced within the zones of interest 143, 146. As described in more detail below, the disclosed embodiments make use of real-time LWD measurements to update the prescribed sampling plan and to identify desired regions (zones of interest) within the wellbore to acquire additional samples (e.g., closed spaced samplings as depicted).

The disclosed embodiments may advantageously provide timely notification to a driller that a zone of interest has been entered and that additional formation gas, drilling fluid, and/or cuttings samples should be acquired at the surface. In so doing, the disclosed embodiments may improve the quality and value of the master log in that they may provide for an accurate lithology description based upon an increased number of samples in a particular zone (or zones) of interest. Moreover, the disclosed embodiments may optionally enable the depth interval of the scheduled samplings to be increased (e.g., as depicted schematically in FIG. 2) and may thereby reduce the number of trips made by mud logging personnel to the shale shakers and mud pits to acquire samples. In this way, the disclosed embodiments may provide for an improved master log while at the same time reducing health, safety, and environmental risk exposure of rig personnel.

FIG. 3 depicts a flow chart of one example method 200 for classifying a downhole event and optionally updating or modifying a surface logging sampling plan in real-time while drilling. The method 200 includes making or acquiring logging while drilling (LWD) measurements while drilling a wellbore at 202. The LWD measurements may include substantially any LWD measurements, for example, including formation density measurements, resistivity measurements, sonic measurements, and/or ultrasonic measurements. Moreover, while not limited in this regard, the LWD measurements may advantageously include azimuthally resolved LWD images.

The LWD measurements (e.g., the images) may be received by a downhole processing system at 204 (e.g., located in the BHA in close proximity to the LWD tool or tools). The downhole processing system includes a trained deep learning model or an artificial intelligence model, such as a trained convolution neural network (CNN), configured to classify a downhole event that causes a change in the composition of annular drilling fluid in the wellbore. The received LWD measurements are evaluated at 206 using the trained deep learning model to identify and classify a drilling event. A zone of interest may be identified at 208 from the deep learning model classification, for example, when the deep learning model outputs a preselected classification (such as gas bubbles in the annular drilling fluid). Additional mud logging samples (e.g., cuttings, fluid, and/or gas) may be acquired at 210 when a zone of interest is identified at 208.

In example embodiments, the downhole processing system may be configured to identify the zone of interest at 208 and prepare a notification for transmission to the surface (e.g., via known telemetry techniques). Upon receiving the notification, mud logging personnel may acquire the additional mud logging samples. In another example the downhole processing system may be configured to identify times at which the classification in 206 changes from one event type to another. This change may trigger the preparation of a notification for transmission to the surface. Again, mud logging personnel may acquire the additional mud logging samples. In still another embodiment, the deep learning model classification may be transmitted to the surface and the zone of interest may be identified at the surface based upon the classification. The disclosed embodiments are not limited in these regards.

While the disclosed embodiments may make use of substantially any LWD measurements in 202, sonic LWD, ultrasonic LWD, and electromagnetic LWD imaging measurements may be particularly advantageous. In such advantageous embodiments, sonic LWD, ultrasonic LWD, and/or electromagnetic LWD imaging measurements may be used to sense drill cuttings and/or gas bubbles in drilling fluid in the wellbore annulus. It will be appreciated that the presence of cuttings and/or bubbles in the drilling fluid may cause an abrupt change in the LWD measurement, for example, owing to a change in impedance or reflected energy. Such measurement changes may be considered to be undesirable artifacts during standard LWD measurements (in that they do not indicate properties of the intact formation). Another aspect of the disclosed embodiments was the realization that such “artifacts” may be used to identify zones of interest within the subterranean formation (e.g., by sensing the influx of gas bubbles or by sensing a change in the cuttings particles).

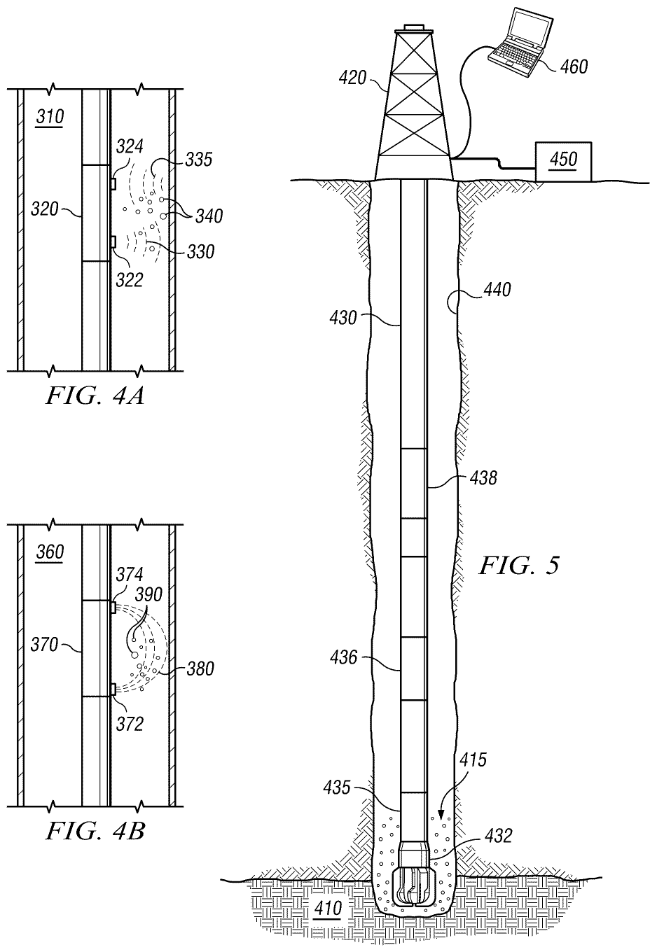

FIGS. 4A and 4B (collectively FIG. 4) depict ultrasonic LWD (4A) and electromagnetic LWD (4B) measurements being impacted by cuttings particles and/or gas bubbles in the drilling fluid. In FIG. 4A, ultrasonic LWD tool 320 emits ultrasonic energy 330 into a wellbore annulus 310 using transmitter 322. In the depicted example illustration, a portion of the ultrasonic energy 335 reflects off of gas bubbles 340 in the annulus 310 back to an ultrasonic receiver 324. It will be appreciated that the return signal received at the receiver 324 may be influenced by the interaction of the ultrasonic energy with the gas bubbles 340 (in addition to ultrasonic energy that reflects off the borehole wall and penetrates the formation). It will be further appreciated that ultrasonic energy may also reflect off of cuttings particles (not shown in this example illustration). In some example embodiments, the gas bubbles and/or cuttings particles may introduce noise into the LWD measurements such that a change in the nature or size of the cuttings particles or the presence or absence of gas bubbles may cause a change in the amplitude of the measurement noise. In such embodiments, quantifying (or otherwise evaluating) the LWD measurement noise may enable the presence or absence of gas bubbles and/or the size (e.g., small or large) of the cuttings particles to be discerned. It will be appreciated that LWD measurement noise or imaged measurement noise along with corresponding measurement labels may be used to train a deep learning model.

In FIG. 4B, electromagnetic LWD tool 370 emits electromagnetic energy 380 into a wellbore annulus 360 using transmitter 372. In example embodiments, the transmitter may be configured to emit low amplitude electromagnetic energy 380 (e.g., less than a threshold) such that the electromagnetic energy remains in the annulus and does not enter the formation (although the disclosed embodiments are not limited in this regard). The transmitted electromagnetic energy may be received at a receiver 374. The received electromagnetic energy may be evaluated, for example, to determine an impedance of the drilling fluid in the annulus. In example embodiments, impedance maps (images) may be generated in which the impedance is evaluated as a function of azimuthal angle and measured depth in the wellbore. It will be appreciated that changes in the content of the drilling fluid may be measured as a change in impedance. In this way, the presence or absence of gas bubbles 390 and/or the amount and size of the drill cuttings particles may influence the measured impedance. By recording this impedance in time series format or in an image format, changes in the impedance may create a signature related to as downhole event (e.g., entering a formation zone of interest). The LWD impedance measurements (e.g., images) along with corresponding labels may be used to train a deep learning model.

With reference again to FIG. 3, additional measurements may be made at 202. For example, the additional measurements may include time series mud density, natural gamma rays, volumes, return flow, rate of penetration (ROP), annular pressure and temperature, and etc. These additional time series measurements may be evaluated along with the LWD measurements at 204 to identify the zone of interest. The times series measurements may be processed by the deep learning model (in combination with the LWD measurements) or by a separate (distinct) model. The additional data may be used to identify acoustic or electromagnetic images that are impacted by cuttings and/or gas bubbles in the drilling fluid.

In addition to the use of the Deep Learning model to classify the LWD images, other machine learning (ML) models may be used to analyze the time series data to detect anomalies. For example, cuttings particles or gas bubbles may be detected using outlier-detection algorithms (i.e., algorithms that are configured to detect abnormal values of the sensor measurement) to account for cutting-induced artifacts. The outlier-detection algorithms may assume that a frequency of the abrupt changes is sufficiently high to detect the outlier over a background signal and that a signal-to-noise ratio (SNR) is strong. In example, embodiments a sudden increase in mud density may indicate increased cuttings in the drilling fluid. Likewise, a sudden decrease in mud density may indicate the presence of gas bubbles in the drilling fluid.

It will be appreciated that in general the above described LWD tools emit an excitation signal and measure a return signal that results from the excitation signal interacting with the borehole (and in particular with the formation and the drilling fluid inside of the borehole). The received return signal (the LWD measurement) may then be evaluated to determine whether the measurement was acquired over a time interval during which an abrupt change to the measurement may have occurred owing to the presence of cuttings and/or gas bubbles in the drilling fluid. In example embodiments, the acoustic, ultrasonic, and/or electromagnetic emitters and sensors (e.g., transmitters, receivers, etc.) may advantageously have a concentrated spatial sensitivity (a sensitivity window) that is located near and in front of the sensor (the transmitter and receiver). In such embodiments, the sensor may be sized and shaped to provide a sensitivity volume that remains primarily in the annulus only (e.g., not extending significantly into the formation). Such sensor embodiments may advantageously provide improved sensitivity to cuttings particles and/or bubbles in the drilling fluid.

As described above with respect to FIG. 4A, in example acoustic and ultrasonic LWD measurements, gas bubbles and cuttings particles in the drilling fluid may introduce noise into the LWD measurements such that a change in the nature or size of the cuttings particles or the presence or absence of gas bubbles may cause a change in the amplitude of the measurement noise. This may be expressed mathematically, for example, as follows:

$$y = h * s + n$$

where y represents the measured LWD signal, h*s represents a convolution of the input signal s (or transmitted energy) and the impulse response h of the cutting and gas bubble free environment surrounding the sensor, and n represents the measurement noise (e.g., a white noise) induced by cuttings and/or gas bubbles in the drilling fluid. In such LWD operations, changes in the size and nature of the objects (cuttings and/or gas bubbles) in the annulus influence the nature of the noise n such that labeled measurements (with corresponding noise) may be used to train the deep learning model for prediction.

As also noted above, additional measurements (in addition to the LWD measurements) may be monitored. For example, the mud weight w may be obtained from downhole hydrostatic pressure p measurements, for example, as follows:

$$w = d ( p ) \cdot h$$

where d(p) represents the density of the drilling fluid (and indicates that the density is a function of the hydrostatic pressure) and h represents the true vertical depth of the measurement. The mud weight w may be obtained as follows:

$$w = p \cdot s$$

where p represents the hydrostatic pressure and s represents the cross-section of the wellbore such that:

$$d = \frac{p \cdot s}{h}$$

With reference again to FIG. 4A, the ultrasonic LWD measurements may further include Doppler frequency shift measurements. A Doppler frequency shift may be observed owing to movement of gas bubbles and/or cuttings particles in the annulus. In such embodiments, Doppler ultrasonic transmitting and receiving modules may be deployed in the ultrasonic LWD tool. The received ultrasonic signals may be analyzed for a Doppler frequency shift that may be indicative of gas bubbles and/or cuttings particles in the drilling fluid. In example implementations the volume fraction of gas bubbles or cuttings particles in the drilling fluid may be estimated based on the magnitude of the Doppler frequency shift (as the Doppler frequency shift tends to increase with increasing volume fractions of gas bubbles and/or cuttings particles).

FIG. 5 depicts a schematic of an example drilling operation implementing the disclosed system and method for detecting a zone of interest (and optionally adjusting a mud logging sampling plan). In FIG. 5 a drilling rig 420 is positioned over a subterranean formation (including zone of interest 410). The rig 420 includes a drill string 430, which, as shown, extends into wellbore 440 and includes, for example, a drill bit 432, one or more LWD tools 435 (as well as other optional measurement tools) and a downhole processing system 436 including a trained deep learning and/or machine learning model. As described in more detail below, the processing system 436 may be configured to evaluate the LWD (and other optional) measurements to classify a downhole event. The drill string 430 may further include an MWD tool 438 including a telemetry system (such as a mud pulse, mud siren, or electromagnetic telemetry system) that is configured to transmit the classification or a corresponding notification to the surface.

With reference again to FIG. 3, and continued reference to FIG. 5, the LWD tool(s) 435 acquire LWD (and other optional) measurements at 202. As described above, the measurements may include, for example, acoustic, ultrasonic, and/or electromagnetic LWD measurements (such as LWD imaging measurements) as well as other measurements such as hydrostatic pressure and mud weight (or density). The measurement data may be received and evaluated at 204, 206 using a deep learning model deployed in a downhole processing system 436. The deep learning model may be configured, for example, to identify a drilling event and to classify the event as one that generates gas bubbles, large cuttings particles, or small cuttings particles in the annular drilling fluid. As described above, the event may be identified, in part, by a change in electromagnetic impedance, an increase in ultrasonic measurement noise, and/or an increased ultrasonic Doppler frequency shift. The downhole processing system may be further configured to identify a zone of interest from the event classification at 208 and to prepare a notification for subsequent transmission to the surface (e.g., via a telemetry system in MWD tool 438).

As further depicted in the example FIG. 5 schematic, the drill bit 432 has penetrated a zone of interest 410 causing a release of gas bubbles 415 into the annular drilling fluid. As described above, these gas bubbles may be detected in the LWD measurements (e.g., as a change in electromagnetic impedance, an increase in ultrasonic noise, and or a Doppler frequency shift). The deep learning model deployed in the processing system 436 may classify the event as one that generates gas bubbles in the drilling fluid (a gas influx event). The processing system may then identify the event as a zone of interest and send a notification to the telemetry tool 438, which in turn may transmit a gas bubble event notification to the surface along with a timestamp (from which the measured depth may be estimated). Upon receiving the telemetry notification at a surface controller 460 (e.g., DrillOps® available from SLB), a mud logger or other rig personnel may optionally go to the surface system 450 (e.g., to the shale shakers or mud pits) and retrieve additional gas, fluid and/or cuttings samples at 210.

FIG. 6 depicts a block diagram of an example event classification 500. Acoustic and/or ultrasonic LWD measurements 502, electromagnetic LWD measurements 504, and/or other measurements 506 are received by a deep learning model 510 deployed in a downhole processing system. The downhole processing system may include a digital engine including one or more microprocessors with dedicated memory (e.g., NAND flash memory), however, the disclosed embodiments are not limited in this regard. In example embodiments, the deep learning model may be trained to evaluate LWD measurements 502, electromagnetic LWD measurements 504, and/or other measurements 506 and to classify the event into one of three classes, a first gas influx event in which the drilling fluid includes gas bubbles 522, a second event in which the drilling fluid contains primarily small cuttings particles 524, or a third event in which the drilling fluid contains primarily large cuttings particles 526.

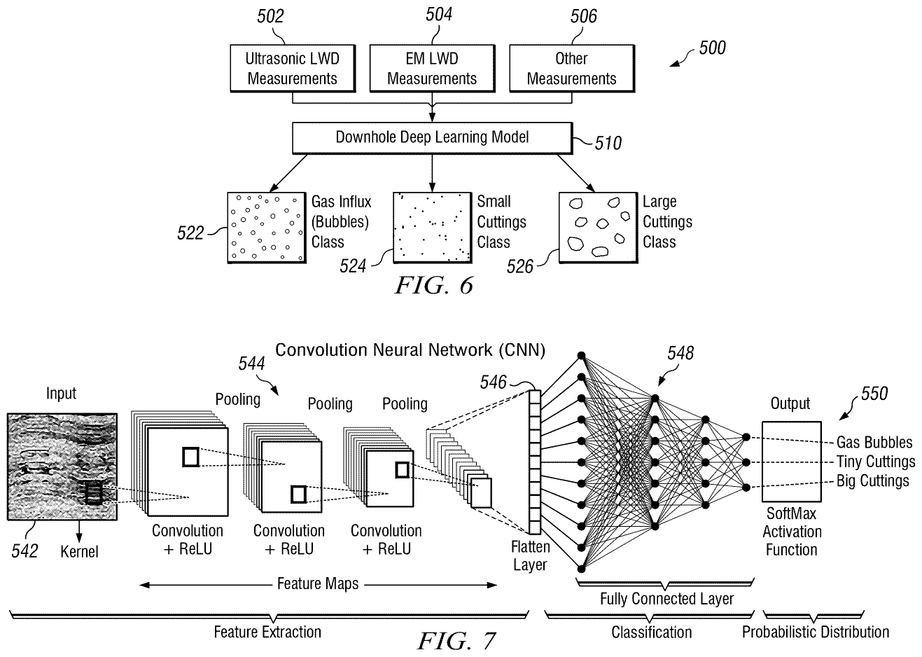

FIG. 7 depicts a block diagram of a convolutional neural network (CNN) configured for receiving LWD measurement kernels and outputting an event classification. The depicted example CNN is particularly well suited for image classification and may receive one or more input LWD images 542 (also referred to as kernels). As depicted, the image(s) may be passed through a plurality of convolutional and pooling layers 544 to generate feature maps. The multidimensional feature maps are then passed through a Flatten layer 546 to transform the feature maps into a one-dimensional array. The one-dimensional array may then be received by a fully connected neural network 548 which outputs a probability classification indicating the probability of the event being a gas influx event, a small cuttings event, or a large cuttings event as indicated at 550. While FIG. 7 depicts a CNN deep learning model, and while CNN models have been found to be particularly advantageous, it will be appreciated that the disclosed embodiments are not limited in this regard. Other suitable deep learning models may include, for example, decision trees (DT), k-nearest neighbors (KNN), support vector machine (SVM), and long short-term memory (LSTM).

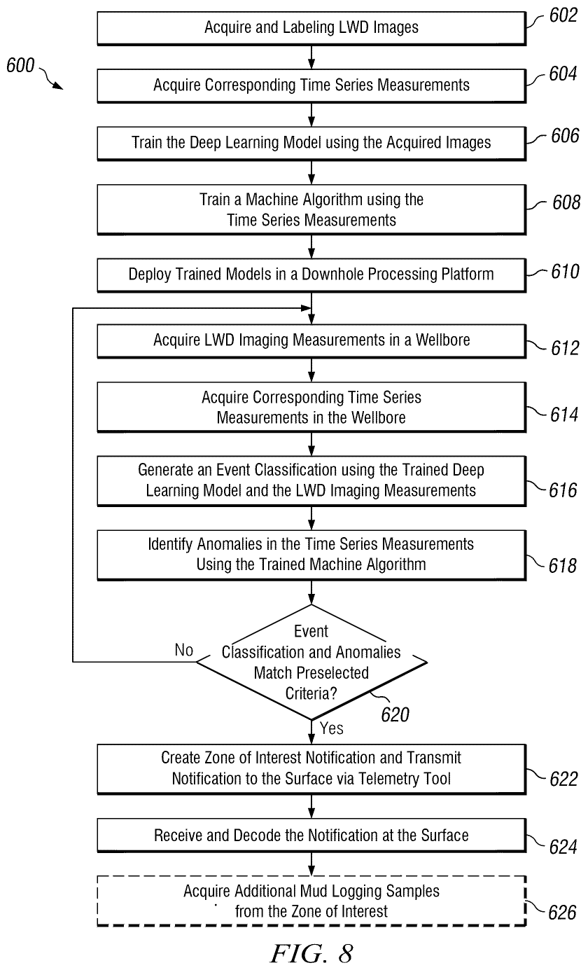

FIG. 8 depicts an example method 600 for classifying a drilling event. The method 600 includes acquiring and labelling LWD images at 602. As described above, the LWD images may include, for example, acoustic, ultrasonic, Doppler frequency shift, and/or electromagnetic LWD images. The images may be labeled with various classifications such as gas influx (bubbles), small cuttings particles, or large cuttings particles. Time series measurements are acquired at 604. By time series it is meant that the measurements are delineated in time during a drilling operation and are not further processed to form an image. The time series measurements may include, for example, mud density or mud weight measurements (e.g., computed from hydrostatic pressure measurements), natural or induced gamma ray measurements, rate of penetration measurements, and/or drilling fluid return flow rate at the surface. The acquired and labeled LWD images may be used at 606 to train a deep learning model such as a CNN. The time series data may be used at 608 to train a machine algorithm to detect anomalies in the annular drilling fluid.

The trained deep learning model and machine algorithm may be deployed in a downhole processing platform (e.g., in a processing or computing sub) which may be in turn deployed in a wellbore during a drilling operation at 610. LWD image measurements may be made in the wellbore (while drilling) at 612. Corresponding time series measurements may be made at 614. The LWD image measurements (the images) may be evaluated at 616 using the deep learning model to classify a downhole event (e.g. an event that produces bubbles in the annular drilling fluid, an event that produces small cuttings particles in the annular drilling fluid, or an event that produces large cuttings particles in the annular drilling fluid). The time series data may be evaluated at 618 with the machine algorithm to detect anomalies in the annular drilling fluid.

The outputs from the deep learning model (the classification) and the machine algorithm (the anomalies) may be compared with preselected criteria at 620. When the outputs match the preselected criteria, a notification is created (e.g., with the event type, time, and depth) and transmitted to the surface at 622 (e.g., via mud pulse or siren telemetry or via electromagnetic telemetry). Otherwise, the method may return to 612. While the disclosed embodiments are not limited in this regard, the preselected criteria may include a particular classification with a complementary anomaly detection. For example, a gas influx event may be detected when the event is classified as gas bubbles in the annular drilling fluid and the drilling fluid density is less than an expected density based on the measured depth of the well. In another example, a washout or wellbore wall collapse event may be detected when the event is classified as large cuttings particles in the annular drilling fluid and the drilling fluid density is greater than an expected density based on the measured depth of the well. In still another example, a formation transition event may be detected when the event is classified as small cuttings particles in the annular drilling fluid, the drilling fluid density is greater than an expected density based on the measured depth of the well, and the rate of penetration increases. It will be appreciated that the disclosed embodiments are not limited to any particular event or event type. However, the disclosed embodiments have been found to be particularly useful and suitable for detecting gas influx events.

With continued reference to FIG. 8, the transmitted notification may be received and decoded at the surface at 624. A corresponding gas, fluid, and/or cuttings sample may then be optionally acquired at 626 in response to the notification. It will be appreciated that surface personnel may further evaluate surface measurements (e.g., ROP, torque, weight on bit, etc.) and then may ultimately accept or reject the received and decoded notification.

It will be understood that the present disclosure includes numerous embodiments. These embodiments include, but are not limited to, the following embodiments.

In a first embodiment, a method for classifying a downhole event while drilling comprises making logging while drilling (LWD) measurements in a wellbore penetrating a subterranean formation; receiving the LWD measurements in a downhole processing system, the downhole processing system including a trained deep learning model; classifying a drilling event by evaluating the received LWD measurements with the trained deep learning model, the drilling event causing a change in at least one property of annular drilling fluid in the wellbore, the classification classifying a change in a composition of the annular drilling fluid; and identifying a zone of interest in the subterranean formation from the deep learning model classification.

A second embodiment may include the first embodiment, wherein the identifying is performed by the downhole processing system; and after identifying the zone of interest, the downhole processing system further generates a notification for telemetry transmission to a surface location.

A third embodiment may include the second embodiment, further comprising acquiring one or more samples of drill cuttings from the zone of interest.

A fourth embodiment may include any one of the first through third embodiments, wherein the zone of interest is identified when the classification indicates that the annular drilling fluid contains gas bubbles.

A fifth embodiment may include any one of the first through fourth embodiments, wherein the classification classifies the drilling event into one of at least three classes, a first class in which the annular drilling fluid contains gas bubbles, a second class in which the annular drilling fluid contains primarily small cuttings particles, and a third class in which the annular drilling fluid contains primarily large cuttings particles.

A sixth embodiment may include any one of the first through fifth embodiments, wherein the LWD measurements comprise ultrasonic LWD measurements; and the drilling event causes an increase in a measurement noise in the LWD measurements.

A seventh embodiment may include any one of the first through sixth embodiments, wherein the LWD measurements comprise ultrasonic Doppler LWD measurements; and the drilling event causes a Doppler frequency shift in the LWD measurements.

An eighth embodiment may include any one of the first through seventh embodiments, wherein the LWD measurements comprise electromagnetic LWD measurements; and the drilling event causes a change in a measured impedance of the annular drilling fluid.

A ninth embodiment may include any one of the first through eighth embodiments, wherein the making LWD measurements further comprises determining a drilling fluid density or a drilling fluid weight from downhole hydrostatic pressure measurements; and the identifying and classifying the drilling event further evaluates the determined drilling fluid density or drilling fluid weight with the trained deep learning model.

A tenth embodiment may include any one of the first through ninth embodiments, wherein the trained deep learning model comprises a trained convolutional neural network.

In an eleventh embodiment a downhole tool string comprises at least one logging while drilling (LWD) tool configured make LWD measurements in a wellbore; a downhole processing system configured to receive the LWD measurements, the downhole processing system including a trained deep learning model, the trained deep learning model configured to classifying a drilling event by evaluating the received LWD measurements with the trained deep learning model, the drilling event causing a change in at least one property of annular drilling fluid in the wellbore, the classification classifying a change in a composition of the annular drilling fluid, the downhole processing system further configured to identifying a zone of interest in the subterranean formation from the deep learning model classification and after identifying the zone of interest generate a notification for telemetry transmission to a surface location; and a downhole telemetry tool configured to transmit the notification to the surface location.

A twelfth embodiment may include the eleventh embodiment, wherein the deep learning model comprises a convolutional neural network that is configured to classify the drilling event into one of at least three classes, a first class in which the annular drilling fluid contains gas bubbles, a second class in which the annular drilling fluid contains primarily small cuttings particles, and a third class in which the annular drilling fluid contains primarily large cuttings particles.

A thirteenth embodiment may include any one of the eleventh through twelfth embodiments, wherein the downhole processing system is configured to identify the zone of interest when the classification indicates that the annular drilling fluid contains gas bubbles.

A fourteenth embodiment may include any one of the eleventh through thirteenth embodiments, wherein the LWD tool comprises at least one of the following an ultrasonic LWD tool measurements, wherein the processing system identifies the drilling event by an increase in measurement noise in ultrasonic LWD measurements; an ultrasonic Doppler LWD tool, wherein the processing system identifies the drilling event by a Doppler frequency shift in ultrasonic Doppler LWD measurements; and an electromagnetic LWD tool, wherein the processing system identifies the drilling event by a change in measured impedance of the annular drilling fluid.

A fifteenth embodiment may include any one of the eleventh through fourteenth embodiments, further comprising a pressure sensor configured to make hydrostatic pressure measurements, wherein the downhole processing system is configured to compute a drilling fluid density or a drilling fluid weight from the hydrostatic pressure measurements and is further configured to identifying the zone of interest in the subterranean formation from the deep learning model classification and the drilling fluid density or the drilling fluid weight.

In a sixteenth embodiment a method for classifying a downhole event while drilling comprises making logging while drilling (LWD) imaging measurements in a wellbore penetrating a subterranean formation; making time series measurements in the wellbore corresponding to the LWD imaging measurements; receiving the LWD imaging measurements and the time series measurements in a downhole processing system, the downhole processing system including a trained deep learning model configured to evaluate the LWD imaging measurements and a trained machine algorithm configured to evaluate the time series measurements; classifying a drilling event by evaluating the received LWD imaging measurements with the trained deep learning model, the drilling event causing a change in at least one property of annular drilling fluid in the wellbore, the classification classifying a change in a composition of the annular drilling fluid; identifying anomalies in the times series measurements using the trained machine algorithm; and identifying a zone of interest in the subterranean formation when the drilling event classification matches a preselected classification and when an anomaly is identified.

A seventeenth embodiment may include the sixteenth embodiment, further comprising generating a notification for telemetry transmission to a surface location; and acquiring a sample of cuttings particles at the surface location in the identified zone of interest.

An eighteenth embodiment may include any one of the sixteenth through seventeenth embodiments, wherein the zone of interest is identified when the classification indicates that the annular drilling fluid contains gas bubbles and the identified anomaly is a drilling fluid density that is less than an expected density based on the measured depth of the wellbore.

A nineteenth embodiment may include any one of the sixteenth through eighteenth embodiments, wherein the classification classifies the drilling event into one of at least three classes, a first class in which the annular drilling fluid contains gas bubbles, a second class in which the annular drilling fluid contains primarily small cuttings particles, and a third class in which the annular drilling fluid contains primarily large cuttings particles.

A twentieth embodiment may include any one of the sixteenth through nineteenth embodiments, wherein the LWD imaging measurements comprise at least one of ultrasonic LWD imaging measurements, ultrasonic Doppler LWD imaging measurements, and electromagnetic LWD imaging measurements; and the time series measurements comprise at least one of drilling fluid density measurements and drilling fluid weight measurements derived from hydrostatic pressure measurements.

Although downhole event detection and modified mudlogging sampling has been described in detail, it should be understood that various changes, substitutions and alternations can be made herein without departing from the spirit and scope of the disclosure as defined by the appended claims.

1. A method for classifying a downhole event while drilling, the method comprising:
making logging while drilling (LWD) measurements in a wellbore penetrating a subterranean formation;
receiving the LWD measurements in a downhole processing system, the downhole processing system including a trained deep learning model;
classifying a drilling event by evaluating the received LWD measurements with the trained deep learning model, the drilling event causing a change in at least one property of annular drilling fluid in the wellbore, the classification classifying a change in a composition of the annular drilling fluid; and
identifying a zone of interest in the subterranean formation from the deep learning model classification.

2. The method of claim 1, wherein:
the identifying is performed by the downhole processing system; and
after identifying the zone of interest, the downhole processing system further generates a notification for telemetry transmission to a surface location.

3. The method of claim 2, further comprising acquiring one or more samples of drill cuttings from the zone of interest.

4. The method of claim 1, wherein the zone of interest is identified when the classification indicates that the annular drilling fluid contains gas bubbles.

5. The method of claim 1, wherein the classification classifies the drilling event into one of at least three classes, a first class in which the annular drilling fluid contains gas bubbles, a second class in which the annular drilling fluid contains primarily small cuttings particles, and a third class in which the annular drilling fluid contains primarily large cuttings particles.

6. The method of claim 1, wherein:
the LWD measurements comprise ultrasonic LWD measurements; and
the drilling event causes an increase in a measurement noise in the LWD measurements.

7. The method of claim 1, wherein:
the LWD measurements comprise ultrasonic Doppler LWD measurements; and
the drilling event causes a Doppler frequency shift in the LWD measurements.

8. The method of claim 1, wherein:
the LWD measurements comprise electromagnetic LWD measurements; and
the drilling event causes a change in a measured impedance of the annular drilling fluid.

9. The method of claim 1, wherein:
the making LWD measurements further comprises determining a drilling fluid density or a drilling fluid weight from downhole hydrostatic pressure measurements; and
the identifying and classifying the drilling event further evaluates the determined drilling fluid density or drilling fluid weight with the trained deep learning model.

10. The method of claim 1, wherein the trained deep learning model comprises a trained convolutional neural network.

11. A downhole tool string comprising:
at least one logging while drilling (LWD) tool configured make LWD measurements in a wellbore;
a downhole processing system configured to receive the LWD measurements, the downhole processing system including a trained deep learning model, the trained deep learning model configured to classifying a drilling event by evaluating the received LWD measurements with the trained deep learning model, the drilling event causing a change in at least one property of annular drilling fluid in the wellbore, the classification classifying a change in a composition of the annular drilling fluid, the downhole processing system further configured to identifying a zone of interest in the subterranean formation from the deep learning model classification and after identifying the zone of interest generate a notification for telemetry transmission to a surface location; and
a downhole telemetry tool configured to transmit the notification to the surface location.

12. The system of claim 11, wherein the deep learning model comprises a convolutional neural network that is configured to classify the drilling event into one of at least three classes, a first class in which the annular drilling fluid contains gas bubbles, a second class in which the annular drilling fluid contains primarily small cuttings particles, and a third class in which the annular drilling fluid contains primarily large cuttings particles.

13. The system of claim 11, wherein the downhole processing system is configured to identify the zone of interest when the classification indicates that the annular drilling fluid contains gas bubbles.

14. The system of claim 11, wherein the LWD tool comprises at least one of the following:
an ultrasonic LWD tool measurements, wherein the processing system identifies the drilling event by an increase in measurement noise in ultrasonic LWD measurements;
an ultrasonic Doppler LWD tool, wherein the processing system identifies the drilling event by a Doppler frequency shift in ultrasonic Doppler LWD measurements; and
an electromagnetic LWD tool, wherein the processing system identifies the drilling event by a change in measured impedance of the annular drilling fluid.

15. The system of claim 11, further comprising a pressure sensor configured to make hydrostatic pressure measurements, wherein the downhole processing system is configured to compute a drilling fluid density or a drilling fluid weight from the hydrostatic pressure measurements and is further configured to identifying the zone of interest in the subterranean formation from the deep learning model classification and the drilling fluid density or the drilling fluid weight.

16. A method for classifying a downhole event while drilling, the method comprising:
making logging while drilling (LWD) imaging measurements in a wellbore penetrating a subterranean formation;
making time series measurements in the wellbore corresponding to the LWD imaging measurements;
receiving the LWD imaging measurements and the time series measurements in a downhole processing system, the downhole processing system including a trained deep learning model configured to evaluate the LWD imaging measurements and a trained machine algorithm configured to evaluate the time series measurements;
classifying a drilling event by evaluating the received LWD imaging measurements with the trained deep learning model, the drilling event causing a change in at least one property of annular drilling fluid in the wellbore, the classification classifying a change in a composition of the annular drilling fluid;
identifying anomalies in the times series measurements using the trained machine algorithm; and
identifying a zone of interest in the subterranean formation when the drilling event classification matches a preselected classification and when an anomaly is identified.

17. The method of claim 16, further comprising:
generating a notification for telemetry transmission to a surface location; and
acquiring a sample of cuttings particles at the surface location in the identified zone of interest.

18. The method of claim 16, wherein the zone of interest is identified when the classification indicates that the annular drilling fluid contains gas bubbles and the identified anomaly is a drilling fluid density that is less than an expected density based on the measured depth of the wellbore.

19. The method of claim 16, wherein the classification classifies the drilling event into one of at least three classes, a first class in which the annular drilling fluid contains gas bubbles, a second class in which the annular drilling fluid contains primarily small cuttings particles, and a third class in which the annular drilling fluid contains primarily large cuttings particles.

20. The method of claim 16, wherein:
the LWD imaging measurements comprise at least one of ultrasonic LWD imaging measurements, ultrasonic Doppler LWD imaging measurements, and electromagnetic LWD imaging measurements; and
the time series measurements comprise at least one of drilling fluid density measurements and drilling fluid weight measurements derived from hydrostatic pressure measurements.
